(19) United States
(12) Patent Application Publication
(10) Pub. No.: US 2011/0220579 A1
(43) Pub. Date: Sep. 15, 2011

(54) REMOVAL OF METAL IONS FROM AQUEOUS EFFLUENTS

(75) Inventors: Jean-Marie BASSET, Caluire (FR); Grégory Godard, Genilac (FR); Jean-Pierre Candy, Caluire (FR)

(73) Assignee: CENTRE NATIONAL DE LA RECHERCHE SCIENTIFIQUE (C.N.R.S.), Paris (FR)

(21) Appl. No.: 13/113,350

(22) Filed: May 23, 2011

Related U.S. Application Data
(62) Division of application No. 10/525,252, filed on Sep. 19, 2005.

(30) Foreign Application Priority Data
Aug. 23, 2002 (FR) 0210519

(51) Int. Cl. C02F 1/42; C02F 1/62; C02F 1/64

(52) U.S. Cl. 210/688; 210/681; 210/263

(57) ABSTRACT

The invention relates to a method of reducing the ionic metal content of aqueous effluents. The inventive method consists in bringing an aqueous effluent loaded with metal ions into contact with at least one hydrogen-covered metal.

### CROSS REFERENCE TO RELATED APPLICATIONS

This application is a division of application Ser. No. 10/525,252 filed on Sep. 19, 2005; which is the 35 U.S.C. 371 national stage of International application PCT/FR03/02550 filed on Aug. 19, 2003; which claimed priority to French application 0210519 filed Aug. 23, 2002. The entire contents of each of the above-identified applications are hereby incorporated by reference.

### BACKGROUND OF THE INVENTION

The present invention relates to a novel method allowing the removal of metals in ionic form, in solution in water or any aqueous medium, by chemisorption on a solid charge comprising a metal coated with hydrogen.

The presence of metals in aqueous effluents from chemical, petrochemical, agrochemical, pharmaceutical, plastic, metallurgical factories, etc., poses risks which are now known both to the environment and to human and animal health. These metal waste products are often harmful per se, but also when they come into contact with networks for the supply of water, in particular drinking water, and groundwater tables.

As examples of the risks posed by the presence of metals in the trace state in networks for supplying water intended for the population, illnesses may be cited, which can result from human ingestion of traces of lead (saturnism), cadmium (proteinurea, itaï-itaï in Japan), aluminium (Elseihmer), mercury (Minamata disease in Japan), chromium VI (cancer), etc . . .

Worldwide, legislation is becoming increasingly strict with regard to the content of metals in various aqueous effluents produced by industry and in water supply networks. For example, European legislation is particularly strict and gives lower and lower values for content of metals. By way of illustration, the contents tolerated in aqueous industrial waste products are all less than ppm (parts per million by weight). In drinking water, this content must not exceed 50 ppb (parts per billion by weight) for lead or chromium, 5 ppb for cadmium and must even be less than 1 ppb for mercury.

Therefore, it is important to be able to provide methods which allow the content of these metals to be reduced in aqueous effluents, in residual water and, generally, in water, at least to the level of the standards defined by the provisions in force or future provisions.

Some disclosures, such as, for example, patent applications EP 0 515 686, WO 01/62670, DE 43 20 003 and DE 197 45 664, provide for methods for purifying aqueous effluents (in particular, reducing the concentration of arsenic present in water) using iron in the oxidised state.

Other current methods for removing metals from aqueous effluents make use, for example, of precipitation in the form of hydroxides or sulphides or coprecipitation with aluminium, iron or other salts. One of the major disadvantages of these various methods is the processing of the residual slurries which they produce.

Furthermore, these methods make use of methods of physical sorption or ion exchange and consequently apply only to one type of ion. Furthermore, all these methods are reversible, which means that very low contents of metals in the effluents processed can be achieved only with difficulty.

The methods using the technique of cementation (comparable to an oxidation/reduction reaction between the metal in the ionic form to be removed and a zero valency metal) are not acceptable: the aqueous effluents processed contain significant concentrations of products resulting from the cementation operation.

Therefore, there is a need for an efficient method for reducing the content of metal contaminants present in aqueous effluents of all types, the reduction operation allowing contents to be achieved in the order of, or less than, those defined by the various provisions in force.

Another object of the present invention is to provide an effective method which is relatively not expensive and can readily be carried out to reduce the content of metal contaminants present in aqueous effluents of all types.

Another objective of the present invention is to provide a method for reducing the content of metal contaminants present in aqueous effluents of all types, without producing large quantities of waste products which are difficult to process and without disposing of metals, elements or particles which are produced during the processing method in the processed effluent.

It has now been discovered that the above-defined objectives can be achieved, completely or partially, by means of the method of the invention described below. The method according to the present invention allows in particular electrical equipment, which is often expensive, to be dispensed with and avoids problems relating to the processing of slurries, which is often expensive and difficult to carry out.

Thus, the present invention relates to a method allowing the removal, or at the very least the reduction to very low levels, of metals present in ionic form in aqueous media.

In greater detail, the present invention relates to a method for reducing the content of metals in ionic form present in aqueous effluents, characterised in that it comprises the steps of:
a) placing the aqueous effluent, comprising at least a metal Mᵢ in ionic form, in contact with at least a metal Mₕ; and
b) recovering the aqueous effluent.

The claimed method makes use of chemisorption of metal ions, in solution in the contaminated aqueous medium, by a metal Mₕ, said metal Mₕ being coated with hydrogen before and/or during the placing in contact with the metal ion(s) Mᵢ.

The term “metal coated with hydrogen” is intended to refer to a metal which is partially or completely coated with at least a layer of hydrogen. It is known that metals have a greater or lesser capacity for adsorbing hydrogen at the surface thereof. The metal Mₕ coated with hydrogen used in the present invention is a metal which has been subjected to processing so that the hydrogen is adsorbed, completely or partially, on the metal.

Such a metal coated with hydrogen (referred to more simply as Mₕ in the remainder of the present description, unless otherwise indicated) can be obtained according to a number of methods which are known per se. A method which is commonly used consists in passing a flow of gaseous hydrogen over the surface of a metal. Other methods make use of operations for processing the metal with sources of hydrogen, such as, for example, hydrazine and derivatives thereof, sodium or potassium boron hydride, urea and derivatives thereof, etc . . .

Still another method, known as the Raney method, consists, on the basis of an alloy powder of the metal with aluminium, in removing the aluminium with a strong base in solution in water, then, after washing in the warm state, filtering and retaining the powder obtained in a slightly basic, aqueous medium under a neutral atmosphere. By way of example, nickel prepared according to this method (Raney nickel) is commercial and can be used directly in the method of the present invention.

All these methods, and others, are well known to the person skilled in the art or are readily available in patent literature, scientific publications, abstracts from “Chemical Abstracts”, or via the internet.

The metal Mₕ suitable for the method of the present invention is therefore a metal processed with hydrogen or able to fix hydrogen atoms. Thus, the metal Mₕ can comprise one or more metals selected from the transition metals, in particular from the elements of Groups Ib, IIb, IIIb, IVb, Vb, VIb, VIIb and VIII of the Periodic Table of elements. The metal is preferably selected from the elements of Groups Ib, VIIb and VIII of the Periodic Table of elements, more preferably from the elements of Group VIII of the Periodic Table, that is to say, from iron, ruthenium, osmium, cobalt, rhodium, iridium, nickel, palladium and platinum. In an extremely advantageous manner, the metal is selected from nickel, cobalt, palladium, iridium, ruthenium, rhodium and platinum. Extremely satisfactory results have been obtained when the metal Mₕ comprises nickel.

The metal Mₕ which can be used in the chemisorption of the ions of the metal(s) Mᵢ present in aqueous effluents can be used alone or in association with other metals, or in the form of alloys with other metals of the Periodic Table of elements. In particular, it is possible to use cobalt/nickel, palladium/nickel, nickel/tin alloys and the like.

The metal Mₕ involved in the method of the present invention can be used alone, in a colloid solution or deposited on a solid support. It is advantageous to be able to separate readily, after the processing operation, the aqueous effluent, on the one hand, and, on the other hand, the metal Mₕ which comprises the chemisorbed contaminants Mᵢ. Such a separation can be readily carried out according to techniques known per se, such as filtration, decantation, centrifuging, magnetic effect for ferromagnetic metals, etc . . .

When the metal Mₕ is deposited on a solid support, the support is preferably, but in a non-limiting manner, a divided support which is prepared on the basis of one or more elements from Groups II, III or IV of the Periodic Table of elements, such as carbon, aluminium, silicon, titanium, in the oxide or non-oxide form, alone or in combination. Thus, the solid support on which the metal(s) Mₕ is/are deposited is selected, for example, from active carbon, aluminium oxide, silicon oxide, titanium dioxide, zeolites, molecular sieves and mixtures thereof. As a general rule, the supports of the metals Mₕ which can be used according to the present invention are known and generally used, in particular as catalyst supports of heterogeneous catalysis reactions in organic and inorganic chemistry.

The metal Mₕ (coated with hydrogen or non-coated) can be deposited before or after adsorption of hydrogen, or the hydrogen adsorption phase can be carried out together with the phase for depositing the metal on the support. The depositing of the metal Mₕ (coated with hydrogen or non-coated) can be carried out by any technique known to the person skilled in the art, and in particular by impregnation or exchange from its mineral salts or molecular complexes. The deposited salts are decomposed by processing under a flow of reducing, oxidising or neutral gas, at a suitable temperature, advantageously in the order of between 0° C. and 1000° C., preferably between 20° C. and 800° C., depending on the type of metal and the type of gas used.

According to a preferred variant of the invention, the supported or non-supported metal is coated with hydrogen then placed in contact with the aqueous effluent which contains the metal(s) in ionic form and whose content it is desirable to reduce. The use of the metal coated with hydrogen is preferable for a more effective action of the method. However, the presence of hydrogen partially or completely coating the metal is not essential, the flow to be processed optionally being able to contain one or more sources of hydrogen, such as hydrazine or derivatives thereof, sodium or potassium boron hydride, etc . . . , or other sources of hydrogen as defined above.

Alternatively, the metal can be coated with hydrogen in situ, that is to say, during the chemisorption operation itself, by provision, for example, of an external hydrogen source, in particular by passing a current of hydrogen over the supported metal, at a pressure of the hydrogen in the order of, for example, between 0.5 and 100 bar (from 50 to 10000 kPa). The advantage of such hydrogen adsorption in situ is that it is not necessary to carry out replacement of the metal when all of the hydrogen adsorbed on the metal has been used up. For some metals, such as nickel, for example, it has also been observed that the hydrogen adsorbed originates from molecules of water which are themselves contained in the aqueous effluent to be processed. It follows that the metal can regenerate itself during the processing operation of the aqueous effluent.

Furthermore, when the metal Mᵢ is a metal which, in the zero valency state, can adsorb hydrogen (in particular a metal selected from the transition metals, in particular from the elements of Groups Ib, IIb, IIIb, IVb, Vb, VIb, VIIb and VIII of the Periodic Table of elements), the metal Mᵢ which has been chemisorbed itself becomes the metal Mₕ. It is then simply necessary to repeat the hydrogen adsorption operation on the metal in order to perpetuate the reaction, without it being necessary to carry out replacement of the catalyst Mₕ.

It should also be noted that, when the metal Mᵢ is a metal which can adsorb hydrogen (see paragraph [0028] above), and the metal can itself adsorb the hydrogen originating from the water of the aqueous effluent (see paragraph [0027] above), the method according to the present invention can be carried out without it being necessary to regenerate the catalytic material and to carry out replacement thereof. In such cases, the method can be carried out continuously for very long periods of time, practically without any specific maintenance operation relating to the catalytic material.

Thus, the method according to the present invention consists in placing an aqueous effluent which comprises one or more metals Mᵢ in ionic form in contact with a metal Mₕ which is completely or partially coated with hydrogen. Without going into detailed mechanistic considerations, the metal ions Mᵢ, on contact with the hydrogen supported by the metal Mₕ, are chemisorbed on or adjacent to the metal Mₕ.

The term chemisorption, which characterises the present invention, is intended to refer to the creation of a specific, direct or indirect, chemical bond between the metal to be removed and the metal (or adjacent to the metal) which is supported. It is not physical adsorption, which is a phenomenon that is most often balanced and which does not allow the very low levels of metals in water, which constitute the spectacular result of the present invention, to be achieved.

The term specific, direct or indirect, chemical bond is intended to refer to the formation of a metal/metal bond (direct bond) or a metal/atom(s)/metal bond (indirect bond), the atom(s) present in this indirect bond being, for example, one or more atom(s) of oxygen, sulphur or other atoms, which are associated with the metal Mᵢ dissolved in the aqueous effluent.

In the method according to the invention, the metal ions Mᵢ present in the aqueous effluent are consequently fixed to the metal Mₕ (or its support) by a strong chemical bond and are removed in this manner from the aqueous effluent. The method of the present invention is consequently particularly effective, simple to carry out and has a particularly advantageous cost in comparison with other decontamination methods known at present.

The method of the present invention (chemisorption process) can further be improved when the support of the metal Mₕ, and/or the metal Mₕ itself, has/have a large specific surface-area. This allows a first adsorption of large quantities of metal ions present in the aqueous effluent, before refining the process by means of chemisorption on the metal Mₕ.

The method can be carried out at various temperatures, but generally in the order of between approximately 0° C. and approximately 200° C. The method according to the invention is particularly effective at ambient temperature or at temperatures near ambient temperature, which is a definite economic and environmental advantage for processing industrial effluents and water in general. In this manner, temperatures in the order of between approximately 0° C. and approximately 80° C. are completely suitable for the method of the invention, although lower or higher temperatures can be envisaged, in which cases it may be found to be necessary to work under pressure, without this being detrimental to the method claimed.

Similarly, there is no theoretical limitation on the pH value of the aqueous effluent to be processed, provided that the metal ions Mᵢ are soluble in the aqueous medium. The method of the present invention allows the processing of neutral, acid and basic aqueous effluents, or even very acid or very basic effluents. However, it is advantageous to ensure that the acidity or basicity of the aqueous effluent does not chemically attack the metal Mₕ. In this manner, the method of the invention can be carried out, without significant difficulty, with aqueous effluents whose pH value is in the order of between approximately 1 and approximately 14.

The method of the present invention allows, completely unexpectedly, aqueous effluents comprising one or more metals Mᵢ in ionic form to be processed readily and effectively. The metals Mᵢ in ionic form whose content can be drastically reduced by the method according to the present invention are various ionic forms of all the metals and metalloids of the Periodic Table of elements.

Thus, the metals Mᵢ which can be chemisorbed by the method of the invention are the ionic forms of the elements or combinations of elements selected from scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, mercury, aluminium, gallium, indium, thallium, silicon, germanium, tin, lead, arsenic, antimony, bismuth, selenium, tellurium, polonium, iodine, astatine, cerium, praseodymium, neodymium, promethium, samarium, europium, gadolinium, terbium, dysprosium, holmium, erbium, thulium, ytterbium, lutetium, thorium, protactinium, uranium, neptunium, plutonium, americium, curium, berkelium, californium, einsteinium, fermium, mendelevium, nobelium and lawrencium.

Among the metals listed in the preceding paragraph, it is possible to mention in particular scandium, yttrium, lanthanum, actinium, titanium, zirconium, hafnium, vanadium, niobium, tantalum, molybdenum, tungsten, technetium, rhenium, ruthenium, osmium, rhodium, iridium, nickel, palladium, platinum, gold, mercury, gallium, indium, thallium, silicon, germanium, tin, arsenic, antimony, bismuth, selenium, tellurium, polonium, iodine, astatine, praseodymium, neodymium, promethium, samarium, europium, gadolinium, terbium, dysprosium, holmium, erbium, thulium, ytterbium, lutetium, thorium, protactinium, uranium, neptunium, plutonium, americium, curium, berkelium, californium, einsteinium, fermium, mendelevium, nobelium and lawrencium.

The method of the invention is particularly suitable for processing aqueous effluents comprising, in ionic form, one or more of the elements selected from scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, mercury, aluminium, gallium, indium, thallium, silicon, germanium, tin, lead, arsenic, antimony, bismuth, selenium, tellurium, polonium, iodine, astatine, cerium, europium, uranium, neptunium and plutonium.

More particularly, the metals present in aqueous effluents in ionic form whose content can be drastically reduced by the method according to the present invention are the ions of the elements or combinations of elements selected from titanium, vanadium, chromium, manganese, iron, cobalt, nickel, platinum, copper, silver, gold, zinc, cadmium, mercury, aluminium, lead, arsenic, antimony, bismuth, selenium, polonium, cerium, uranium, neptunium and plutonium; in particular selected from titanium, vanadium, nickel, platinum, gold, mercury, arsenic, antimony, bismuth, selenium, polonium, uranium, neptunium and plutonium.

The method of the present invention is quite particularly advantageously used to remove or at least reduce the content in aqueous effluents, of ions of the metals or combinations of metals selected from tin, chromium, cobalt, nickel, copper, zinc, cadmium, mercury, lead, arsenic, antimony, selenium, polonium, uranium, neptunium and plutonium.

It must be understood in the present invention that the method claimed is also effective for all the isotopes of the metals present in the form of ions in the aqueous effluents. In particular, the method according to the present invention can advantageously be used to reduce the content of or to remove radioactive ions, such as, for example, radioactive ions based on cobalt, uranium, neptunium and plutonium.

Metals Mᵢ in ionic form contained in the aqueous effluents, and as have been defined above, can be present in the state of cations, that is to say, charged with one or more positive charges (any possible valencies according to the electron environment of the metal in question) or one or more negative charges (any possible valencies according to the electron environment of the metal in question). By way of non-limiting example, it is possible to mention the ions Cd²⁺, ions Ni²⁺, ions Co²⁺ and ions Fe³⁺.

The metals Mᵢ can also be present in the aqueous effluent in ionic, cationic or anionic, form, and combined with other elements, such as, for example, oxygen, sulphur, inter alia. Examples of such metal ions combined with oxygen are inter alia the ions UO₂²⁺, ions Cr₂O₇²⁻ and ions AsO₄³⁻.

The aqueous effluents for which it is desirable to reduce the content of metal ions Mᵢ can of course contain one or more contaminating ions as defined above. The method according to the present invention allows aqueous effluents charged with chromium and vanadium, uranium and plutonium, but also iron, cobalt and nickel, for example, to be processed.

There is no theoretical constraint in general terms when selecting the metal Mₕ to be used in accordance with the metal Mᵢ to be removed. For example, it is advantageously possible to use nickel to process aqueous effluents charged with nickel and/or cobalt, or palladium coated with hydrogen in order to process effluents charged with iron and/or copper. These examples are given without any limitation and have the sole aim of demonstrating the universality of the method of the invention.

An advantage which is completely specific to the present invention consists in that the method, and in particular the metal Mₕ, is insensitive to the presence of salts present in the aqueous effluents for which it is desirable to reduce the concentration of ions Mᵢ. It has been possible to observe that the ions of the alkaline and alkaline-earth metals, and in particular the ions Li⁺, K⁺, Na⁺, Ca²⁺ and Mg²⁺ which are often present in the form of counter-ions of the metal ions Mᵢ, are not chemisorbed, and thus do not inhibit or spoil the catalytic material Mₕ.

This constitutes a particularly beneficial advantage over the so-called ionic methods of the prior art, where the presence of alkaline or alkaline-earth ions very often has dramatic effects on the yields for removing metal ions Mᵢ.

The kinetics for reducing the content of ions in aqueous effluents depends on a number of factors, and in particular on the type of the aqueous effluent to be processed, the initial concentration of metals, the desired final concentration, but also the type and the quantity of the metal Mₕ used. The kinetics will also depend on the agitation of the medium and/or the specific surface-area of the solid comprising the metal Mₕ. The formation of the bond between the metal Mᵢ and the metal Mₕ is very rapid, or immediate, upon contact; the overall kinetics for processing the aqueous effluent consequently depends on the probability of occurrences of contact between the metal ions Mᵢ and the metal Mₕ.

The method of the present invention in particular allows aqueous effluents to be processed whose concentration of contaminating metal ions Mᵢ is in the order of 10000 ppm or above. Of course, the method of the invention allows effluents to be processed whose concentration of contaminants Mᵢ is far less, up to a few ppm or less.

After processing according to the method of the invention, the concentration of metal ions Mᵢ in the aqueous effluent can reach values in the order of from ppb to several hundreds of ppb, in accordance with the quantity of metal Mₕ used, the duration of contact, etc. Of course, the method of the invention can be used under such conditions that the final concentration of metal ions Mᵢ in the aqueous effluent after processing is fixed in the region of ppm or up to several ppm, several tens, hundreds or thousands of ppm, in accordance with the degree of purity desired or required.

The aqueous effluent containing the metal ions Mᵢ of which it is desirable to reduce the content, or remove the presence, can be of any type, so long as it allows complete solubilisation of the metal ions Mᵢ. In this manner, the aqueous effluent can be water, for example, water from groundwater tables, surface water, water distribution networks, industrial water, waste water, but also any types of slurries and industrial wastes. The aqueous medium can thus be homogeneous or heterogeneous, comprise particles in suspension, etc. In this last case, it may be advantageous to carry out filtering of the aqueous effluent before carrying out the method according to the invention, although it is in no way necessary.

According to the type of aqueous effluent to be processed and the content of metal ions Mᵢ, the method of the present invention can be carried out several times successively. The aqueous effluent processed by the method of the invention can again be engaged once or several times during the method of the invention, in particular for the purposes of obtaining a final concentration of metal ions Mᵢ which is as low as possible, or the total removal of the contaminant.

The method of the invention can also be used at least once before or after other processing operations intended to reduce or remove the contaminants in the aqueous effluents. For example, it is possible to envisage the reduction of very high concentrations of contaminants by known techniques (such as precipitation, modification of the pH), then to use the method of the invention as a refining or finishing technique in order to achieve very low concentrations of contaminants, or to remove the contaminants. Alternatively, or at the same time, the method of the invention can be used to roughly reduce the concentration of metal ions Mᵢ, then another finishing technique can be used to achieve the very low concentrations desired. All these combinations comprising at least one processing operation with the claimed method are included within the scope of the present invention.

As indicated above, the metal Mₕ used in the method of the invention can be used as such or deposited on a support. Advantageously, the metal Mₕ, supported or non-supported, can be contained in a receptacle, dispersed in a matrix, etc., in order to facilitate the handling and use thereof. The receptacle or the matrix (or other means) can be based on metal and/or inorganic and/or organic materials (polymers, for example) having variable forms and porosity. The supported or non-supported metal Mₕ, which is optionally in a receptacle and/or dispersed in a matrix, can thus be offered commercially in the form of a kit for decontaminating aqueous effluents. Such a decontamination kit is also part of the present invention.

The decontamination kits are, for example, solid blocks of any form and any size comprising one or more metals Mₕ which are intended to be deposited in vessels or channels for aqueous effluents to be decontaminated, or in the form of filters of variable size and thickness, which are ready for use and which can be installed at the inlet, or at the outlet, or even at the inner side, of channels, valves, taps, or directly in the apertures, openings or necks of the receivers containing the aqueous effluents to be processed.

As indicated above, during the processing of the aqueous effluent by means of the method of the present invention, the metal ions Mᵢ are fixed to or near the metal Mₕ, by a chemical bond, in non-ionic metal form. In this manner, it is possible, by mechanical and/or physical and/or chemical means which are known per se to separate the metal(s) which have been fixed to the metal Mₕ. This technique can be found to be extremely advantageous, in particular from the economic point of view, when the contaminants of the aqueous effluents are expensive or precious metals. It is thus possible to recover, in the metallic form, for example, platinum, gold, silver, cadmium, which were in ionic form in the aqueous effluents before the processing by the method of the present invention.

The following examples illustrate the invention without in any way limiting the scope thereof.

### EXAMPLE 1

### Reducing the Content of Arsenic in an Aqueous Solution

An aqueous solution (60 g) of arsenic in ionic form prepared from an arsenic oxide (As₂O₃), corresponding to 340 ppm by weight of arsenic per weight of solution, is placed in contact with a quantity of Raney nickel (marketed by the company ACROS) corresponding to 0.02 g of nickel per gramme of solution.

After 3 hours of agitation, the solid is removed from the solution by filtration.

The final concentration of arsenic contained in the solution is measured by ICP analysis (“Inductively Coupled Plasma”), that is to say, inductively coupled plasma emission spectrometry. The ICP analysis, whose threshold for detecting arsenic is 5 ppm (by weight of arsenic per weight of solution), does not detect any more arsenic in the solution.

### EXAMPLE 2

### Dynamic Test for Reducing the Content of Cadmium in an Aqueous Solution

A pellet of Raney nickel (ACROS) having a thickness of 1 cm is introduced into a column having a diameter of 1 cm. Under a flow of argon, 250 mL of a solution of cadmium chloride (CdCl₂) titrated as containing 1 ppm of cadmium by weight is forced to pass through that pellet. The flow rate at the outlet of the column is fixed at 10 ml/minute.

The content measured by ICP of cadmium ions in the solution at the column outlet is less than 30 ppb.

### EXAMPLE 3

### Reducing the Content of Chromium in an Aqueous Solution

A solution of Na₂Cr₂O₇ (16 mL at 0.075 M, that is to say, 125 mg of chromium in 16 mL of water) is added to 50 mL of water containing a suspension of 1.0 g of nickel on an aluminium oxide support (58.9% by weight), the nickel being reduced and coated with hydrogen (that is to say, 590 mg of nickel).

After 20 hours of reaction under a hydrogen atmosphere, the content of chromium in solution is 0.1 ppm.

### EXAMPLE 4

### Reducing the Content of Nickel in an Aqueous Solution

A solution of NiCl₂ (20 mL at 0.3 M, that is to say, 360 mg of Ni in 20 mL of water) is added to 50 mL of water containing a suspension of 0.1 g of nickel on an aluminium oxide support (58.9% by weight), the nickel being reduced and coated with hydrogen (that is to say, 59 mg of nickel).

After 20 hours of reaction under a hydrogen atmosphere, the content of Ni in solution is 0.3 ppm. The Ni²⁺ ions are reduced and deposited on the surface of the adsorbent (Ni—H), in order to form a new layer of adsorbent (Ni—H). The reaction catalyses itself.

This example shows that when the metal Mᵢ (nickel in the form of Ni²⁺ ions in this example) is a metal capable of adsorbing hydrogen (a metal capable of acting as the metal Mₕ), the reaction for removing ions automatically regenerates the catalyst and can then be carried out continuously without it being necessary to carry out regeneration of the catalyst or replacement thereof.

1. A method for reducing a content of contaminating elements in ionic form present in aqueous effluents, comprising:
(a) providing an aqueous effluent comprising at least an element Mᵢ in ionic form, the element Mᵢ being at least one selected from the group consisting of scandium, yttrium, lanthanum, actinium, titanium, zirconium, hafnium, vanadium, niobium, tantalum, chromium, molybdenum, tungsten, manganese, technetium, iron, ruthenium, cobalt, rhodium, platinum, copper, silver, zinc, cadmium, mercury, aluminum, gallium, indium, thallium, silicon, germanium, tin, lead, arsenic, antimony, bismuth, selenium, tellurium, polonium, cerium, praseodymium, neodymium, promethium, samarium, europium, gadolinium, terbium, dysprosium, holmium, erbium, thulium, ytterbium, lutetium, thorium, protactinium, uranium, neptunium, plutonium, americium, curium, berkelium, californium, einsteinium, fermium, mendelevium, nobelium and lawrencium, alone or in admixture;
(b) treating the aqueous effluent with at least a nickel having a high specific surface area, completely or partially coated with hydrogen during the treatment of the ion(s) Mᵢ, wherein the ions Mᵢ are chemisorbed on the nickel; and
(c) recovering an aqueous effluent from which the element Mᵢ has been eliminated or its content reduced.

2. The method according to claim 1, wherein the nickel is completely or partially coated with hydrogen before the treatment of the ions Mᵢ which are present in the aqueous effluent.

3. The method according to claim 1, wherein the ions Mᵢ are the ionic forms of the elements or combinations of elements selected from the group consisting of scandium, yttrium, lanthanum, actinium, titanium, zirconium, hafnium, vanadium, niobium, tantalum, chromium, molybdenum, tungsten, manganese, technetium, iron, ruthenium, cobalt, rhodium, platinum, copper, silver, zinc, cadmium, mercury, aluminum, gallium, indium, thallium, silicon, germanium, tin, lead, arsenic, antimony, bismuth, selenium, tellurium, polonium, cerium, europium, uranium, neptunium and plutonium, alone or in admixture.

4. The method according to claim 1, wherein the ions Mᵢ are the ionic forms of the elements or combinations of elements selected from the group consisting of titanium, vanadium, chromium, manganese, iron, cobalt, platinum, copper, silver, zinc, cadmium, mercury, aluminum, lead, arsenic, antimony, bismuth, selenium, polonium, cerium, uranium, neptunium and plutonium, alone or in admixture.

5. The method according to claim 1, wherein the ions Mᵢ are the ionic forms of the elements or combinations of elements selected from the group consisting of tin, chromium, cobalt, copper, zinc, cadmium, mercury, lead, arsenic, antimony, selenium, polonium, uranium, neptunium and plutonium, alone or in admixture.

6. The method according to claim 1, wherein the nickel is deposited on a support.

7. The method according to claim 1, wherein the method is carried out at temperatures in the order of between approximately 0° C. and 200° C.

8. The method according to claim 1, wherein the method is carried out with aqueous effluents whose pH value is in the order of between approximately 1 and approximately 14.

9. The method according to claim 1, wherein the aqueous effluent to be processed is water from groundwater tables, surface water, water distribution networks or industrial water, waster water, slurries or industrial waste.

10. A decontamination kit comprising at least nickel, which is intended to be utilized in the method according to claim 1.

18. The method according to claim 1, wherein the method is carried out at temperatures in the order of between approximately 0° C. approximately 80° C.

19. The method according to claim 1, wherein the nickel is Raney nickel.
